(19) United States
(12) Patent Application Publication
(10) Pub. No.: US 2022/0238969 A1
(43) Pub. Date: Jul. 28, 2022

(54) ELECTRICAL-ACCUMULATOR-ISOLATING DEVICE AND METHOD

(71) Applicant: COMMISSARIAT A L'ENERGIE ATOMIQUE ET AUX ENERGIES ALTERNATIVES, Paris (FR)

(72) Inventors: Julien CHAUVIN, Grenoble cedex 09 (FR); Daniel CHATROUX, Grenoble cedex 09 (FR); Julien DAUCHY, Grenoble cedex 09 (FR); Frédéric GAILLARD, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 17/645,554

(22) Filed: Dec. 22, 2021

(30) Foreign Application Priority Data
Dec. 23, 2020 (FR) 20 14096

(51) Int. Cl. H01M 50/572; H01M 50/543; H01M 50/51

(52) U.S. Cl. CPC H01M 50/572; H01M 50/51; H01M 50/543

(57) ABSTRACT

An electrical-accumulator-isolating device configured to isolate an electrical accumulator of an electrical circuit while ensuring the continuity of the electrical circuit includes first-third terminals and a bypass chamber in which is placed a bypass device that has two bypass conductors separated by a gap. One of the bypass conductors is connected to the second terminal and the other bypass conductor is connected to the third terminal. A fuse having a conductor made of meltable material is connected between the first terminal and the third terminal. The conductor is made of meltable material placed in the bypass chamber and is configured to transfer in the liquid state to the bypass device.

### TECHNICAL FIELD

The invention relates to the field of managing storage of electrical energy and more particularly relates to safety elements used to make this storage of energy safe.

Electrical accumulators, and in particular electrochemical accumulators, are generally packaged in the form of batteries in which unit elements, generally called cells, are connected in series and/or parallel. The association of these cells in series allows higher voltages to be obtained, and their association in parallel allows higher capacities to be obtained with a view to storing more energy.

Most batteries employed in fields as diverse as electric vehicles, electronic hardware, portable electric tools, etc. generally comprise at least one branch of cells or accumulators in series.

### PRIOR ART

In known batteries that comprise at least one branch of accumulators connected in series, failure of one of the accumulators generally leads to all of the accumulators of this branch being made inoperative.

Known batteries are generally associated with management circuits that for example control the temperatures and voltages of the accumulators. These management circuits may be equipped with circuit-breaking elements, such as transistors or relays, that act in case of failure of an accumulator, to disconnect the battery in its entirety or at least the branch in which the defective accumulator is mounted in series with other accumulators. To respond to failure of an accumulator, an entire branch of the battery, or even the entire battery, is thus generally made inoperative.

There are however solutions for isolating one accumulator exhibiting a fault within a battery. Patent application US20140272491 describes a safety element for a battery cell, this element comprising an internal conductive membrane that is deformed when pressure increases in the accumulator. When the internal pressure of the accumulator exceeds a predetermined value, the membrane short-circuits the two poles of the accumulator, this causing the internal circuit of the battery to be broken by a protective circuit breaker. The described electrical-accumulator-isolating device thus allows one electrical accumulator to be isolated with respect to the rest of the electrical circuit to which it is connected, while short-circuiting the terminals of the defective battery cell. The defective cell is thus isolated and the electrical circuit continues to be supplied with power by any other cells connected in series with the defective cell.

Such an electrical-accumulator-isolating device is activated solely by a fault that causes an increase in the internal pressure of a battery cell.

Moreover, the electrical contact detailed in document US20140272491, allowing the terminals of the faulty cell to be short-circuited, may in the best of cases be of the order of 1 mΩ. This parasitic resistance corresponds, for example for a current of 200 A, to a loss of 40 W, generating problems with transfer and removal of the heat generated by this power. The parasitic resistance of this contact is in addition very dependent on the surface finish and oxidation of the parts making contact.

Moreover, the scientific publication “Power Antifuse Device to Bypass or Turn-off Battery Cells in Safety-Critical and Fail-Operational Systems”, V.R.H. Lorentz et al., published by the IEEE (978-1-5090-4974-5/18, DOI:10.1109/IESES.2018.8349850) describes an electrical-accumulator-isolating device that may be likened to a controlled switch that is composed of two interdigitated power conductors separated by an electrical insulating material. This device is associated with a pyrotechnic element that may be triggered by a signal. The pyrotechnic element, when it is activated, melts a reserve of filler metal, which produces a solder joint between the two power conductors and thus interconnects the power conductors by soldering, so as to isolate one electrical accumulator while maintaining the continuity of the rest of the electrical circuit. Elements external to this isolating device are provided to identify the presence of a fault requiring an accumulator to be isolated, and to trigger accordingly the pyrotechnic element of this accumulator.

### SUMMARY OF THE INVENTION

The aim of the invention is to improve the electrical-accumulator-isolating devices and methods of the prior art.

To this end, the invention relates to an electrical-accumulator-isolating device configured to isolate an electrical accumulator of an electrical circuit while ensuring the continuity of this electrical circuit. This device comprises:
a first terminal intended to connect the isolating device to an electrical accumulator;
a second terminal intended to connect the isolating device to an electrical accumulator and to an electrical circuit;
a third terminal intended to connect the isolating device to an electrical circuit;
a bypass chamber in which is placed a bypass device that comprises two bypass conductors that are separated by a gap, one of the bypass conductors being connected to the second terminal and the other bypass conductor being connected to the third terminal;
a fuse comprising a conductor made of meltable material connected between the first terminal and the third terminal, this conductor made of meltable material being placed in the bypass chamber, and being configured to transfer in the liquid state to the bypass device.

According to another subject, the invention relates to an electrical circuit comprising a first electrical accumulator, at least one second electrical accumulator, and a load supplied with power by these electrical accumulators. This electrical circuit comprises an electrical-accumulator-isolating device such as described above, and:
the first terminal of which is connected to a terminal of the first electrical accumulator;
the second terminal of which is connected to another terminal of the first electrical accumulator, and to a terminal of said load;
a third terminal of which is connected to another terminal of said load;

the electrical-accumulator-isolating device being configured to isolate the first electrical accumulator from the second electrical accumulator and from said load, while ensuring the continuity of the supply of power to said load by the second electrical accumulator.

The expression “the second terminal is connected to a terminal of said load” here defines the fact that this second terminal is either connected directly to the load, or is indirectly connected thereto through the second accumulator and any other additional accumulators.

Likewise, the expression “the third terminal is connected to another terminal of said load” here defines the fact that this third terminal is either connected directly to the load, or is indirectly connected thereto through the second accumulator and any other additional accumulators.

According to one preferred feature, the first electrical accumulator and at least the second electrical accumulator are mounted in series with the load via the fuse.

According to another subject, the invention relates to a method for isolating an electrical accumulator with respect to an electrical circuit, implementing an electrical-accumulator-isolating device such as described above, and comprising the following steps:
subjecting the fuse to an overcurrent that heats the conductor made of meltable material to above its melting point;
transferring at least one portion of the conductor made of meltable material that is in the liquid state to the gap separating the bypass conductors.

The expression “configured to isolate an electrical accumulator of an electrical circuit while ensuring the continuity of this electrical circuit” means precisely that the device allows an accumulator (notably because it is defective) to be placed outside of the electrical circuit and that this accumulator is replaced in the electrical circuit to which it was connected by a bypass allowing continuity to be maintained in this electrical circuit. When this electrical circuit comprises a load supplied with power by other electrical accumulators in series with the isolated accumulator, the isolation of the latter and the bypass allow the other electrical accumulators to continue to supply the load with power.

In the device according to the invention, the resistance of the contact allowing the continuity of the electrical circuit devoid of the electrical accumulator is in principle lower than 100 μΩ, and hence removal of energy will not be a problem in almost all batteries, including the high-powered batteries of electric vehicles.

The invention is particularly advantageous in the case of accumulators in lithium-ion technology, which have the advantage of storing far more energy in small masses and volumes, while being able to deliver high powers when discharged and to withstand high powers when charged, and therefore of being able to be charged in a few tens of minutes for example. The main drawback of lithium-ion chemistries is the risk of thermal runaway, which may result in the accumulator in question affected by a fault catching fire, propagation of the fault to neighboring accumulators, and indeed propagation of the fault to the entire battery. The electrical-accumulator-isolating device according to the invention makes it possible to prevent any risk by isolating a faulty accumulator, while maintaining continuity of service, at least in degraded mode, of the battery.

The invention avoids the need to open the entire circuit and stop the delivery of power, following detection of a fault.

Currently, most electric-vehicle batteries, for example, consist of a single branch of lithium-ion accumulators in series. The capacity of these accumulators is several tens of amp-hours, and the overall voltage varies in the range 300 V to 400 V. The invention allows natural or controlled switching between the state in which the accumulator is connected within the series arrangement by connection via the fuse, and the state in which the accumulator has one of its terminals disconnected, a bypass then allowing the rest of the accumulators of the series-connected accumulators to continue to be used.

With respect to the prior art, in which conventionally a few measurements of local temperature within a whole battery pack are carried out and the entirety of the electrical circuit is opened in case of a fault, the invention may be placed in each accumulator of the battery pack and is able to open only the circuit of the faulty accumulator while ensuring a bypass for current, with a view to ensuring continuity of service. The invention allows the safety of a battery pack to be increased, on the one hand as it acts more rapidly than conventional thermal protective means, with which the temperature must propagate to other cells before being detected, and on the other hand as it ensures the continuity of operation of the assembly, which, depending on the application (passenger transport notably) may prove to be a key safety element.

The invention allows a modularity in the actuation of the isolating device. Actuation by an overcurrent that heats the fuse may be complemented by a command generated by the battery management system, or by any other known mode of actuation (for example, addition of a heatable actuating resistor controlled by the battery management system).

The invention may be external to the accumulator or may be integrated into it.

Embodiments of the invention have the advantage of not requiring electronics, and of not requiring these electronics to be supplied with power to operate. Natural actuation as a result of an overcurrent (or as a result of the pressure in the accumulator or even of temperature) allows high levels of operating safety to be ensured, without requiring redundant and/or fault-tolerant electronics. The actuation reliability enabled by the invention is more particularly important in applications in which the required safety level is very high, such as aeronautics for example.

Contrary to the established rules of the art of electrical protection, according to which short circuits are to be avoided as far as can be, the invention exploits a short-circuit to the ends of the isolating device.

One advantageous application of the invention is to the field of transport and more particularly electric or hybrid vehicles. Specifically, requirements and constraints in the field of electric vehicles are tending to become stricter, as are the risks related to use of accumulator technologies, since the amount of energy stored on-board by the latter is increasing as vehicle range increases. It is thus crucial to provide safety systems that minimize the risk of thermal runaway of the battery pack whatever the (internal or external) nature of the fault.

The invention also allows continuity of service of the battery pack to be ensured. With respect to a road vehicle, this makes it possible to park the vehicle safely, or to end the journey, depending on the severity of the fault that caused the device for isolating a faulty accumulator to be actuated.

Moreover, electric vehicles currently have two batteries, the traction battery, which conventionally delivers 300 V to 400 V, and the accessory battery, which is conventionally a lead-acid battery the nominal voltage of which is 12 V. The accessory battery, which is of the type found in combustion vehicles, is used to power the electronics of the vehicle, and above all safety functions (lighting, operation of hazard warning lights, etc.). The traction battery is currently not considered to be reliable enough to power these functions, since a fault in any one of the accumulators in the battery causes the contactors of the battery to open and the latter to be disconnected. With the invention, the obtained continuity of service may allow the electric architecture of the vehicle to be modified with a view to removing the accessory battery since the main battery is able to ensure continuity of service in case of an accident.

The fact that, currently, electric cars do not provide continuity of service in case of malfunction of an accumulator within the battery pack is accepted because a trained, responsible and attentive driver is present on-board. With respect to the autonomous electric vehicles currently being developed, which take charge of driving to a greater or lesser extent, it would be desirable to ensure a continuity of service for reasons of road safety. Continuity of service may also become obligatory for autonomous vehicles because of the possible absence of a trained and responsible driver able to take charge of driving or to get the vehicle to safety in case of malfunction.

For an airplane or a naval vessel, the continuity of service provided by the invention enables application to critical functions. Specifically, the invention ensures the continuity of service of the battery pack in the case of a fault in an accumulator, this, contrary to the conventional case, allowing the vehicle to continue to operate with a slightly decreased range rather than stopping its operation. This advantage may prove to be very relevant in the field of aeronautics or of marine technology, in which continuity of service is essential. The presented invention is entirely adaptable to the prismatic cells used in a number of transport fields.

The invention has the advantage of being optionally activatable by an external electronic system. For example, the isolating device may be controlled by the airbag system of the vehicle, this allowing all of the accumulators to be electrically isolated from the circuit of the automobile and, contrary to the conventional case, leaving no voltage on the terminals of the pack, ensuring safety during the intervention of first responders because of the absence of risk of electrocution and short-circuit.

This protection provided by the invention is more particularly advantageous in case of complete or partial submergence of the vehicle.

The invention also allows all of the accumulators to be bypassed in the event of the battery catching fire, either due to a fire starting inside the battery, or consecutive to the vehicle catching fire. The absence of voltage as a result of actuation of the invention in all the accumulators allows firefighters to spray the vehicle then to drench the battery without electrical risks and without hydrogen being generated by electrolysis of the water by parts that would normally remain live within the battery.

In the field of accumulators, the voltages employed are only a few volts, and cables low-rating. With respect to the standard conditions under which fuses are used, the invention must deal with a small arc, under low voltage, with a power, giving rise to materials melting and to an electric arc, that is low, and a minimal energy in the cable inductances. These features of the application allow melting of the metal or metal alloy of the fuse to be promoted and vaporization to be limited.

Conventionally, the fuses used for current levels of several hundred amps, such as encountered in electric vehicles, are based on copper in order to minimize resistive losses in the fuse, and involve a small amount of substance. In the context of the invention, the fuse is preferably made from a metal or metal alloy of low melting point, below 400° C. for example, and involves an amount of substance sufficient to produce a solder joint between the bypass conductors, this allowing, in addition, a casing (which will be impacted by the material of the fuse in the liquid state) made of a suitable and inexpensive polymer (polyimide for example) to be employed.

The electrical-accumulator-isolating device according to the invention may comprise the following additional features, alone or in combination:
the conductor made of meltable material is placed facing the bypass conductors;
the fuse is calibrated to ensure the conductor made of meltable material melts when the magnitude of the current flowing through it exceeds a predetermined threshold value;
the bypass conductors are arranged below the fuse, the conductor made of meltable material being configured, when it is in the liquid state, to flow under gravity onto the bypass conductors;
the bypass conductors are arranged all around the fuse, the conductor made of meltable material being configured, when it is in the liquid state, to flow under gravity onto the bypass conductors, whatever the position of the isolating device;
the device comprises a buffer that forces the conductor made of meltable material in the direction of the bypass conductors;
the device comprises an electrical insulator placed between the fuse and the bypass conductors, this electrical insulator being configured to let the conductor made of meltable material pass when the latter is in the liquid state;
the conductor made of meltable material has a melting point below 400° C.,
the bypass conductors have interdigitated complementary geometric shapes, the gap being placed along these geometric shapes;
the bypass conductors have a surface finish configured to be soldered by the material of the conductor made of meltable material when the latter is in the liquid state;
the device comprises at least one control branch placed between the second terminal and the third terminal, in parallel with the bypass device, the control branch comprising at least one controlled switch;
the at least one controlled switch of the control branch comprises a switch switched by a signal;
the at least one controlled switch of the control branch comprises a switch switched by a temperature threshold being crossed;
the at least one controlled switch of the control branch comprises a switch switched by a pressure threshold being crossed;
the fuse comprises two conductors made of meltable materials mounted in parallel, one of these conductors having a melting point above the melting point of the other conductor;
the device comprises a discharge resistor mounted in parallel with the fuse;
the conductor made of meltable material is configured to transfer in the liquid state to the bypass device under gravity, and/or its surface tension, and/or an electromagnetic stress, and/or a permanent elastic mechanical pressure, and/or a heat-activated mechanical pressure (such as thermal contraction or expansion).

### PRESENTATION OF FIGURES

Other features and advantages of the invention will become apparent from the following non-limiting description, with reference to the appended drawings, in which:

FIG. 1 is a first example of an electrical circuit according to the invention;

FIG. 2 is a second example of an electrical circuit according to the invention;

FIG. 3 is a schematic cross-sectional view of an accumulator-isolating device according to a first embodiment of the invention;

FIG. 4 is a view from above of the bypass conductors of the device of FIG. 3;

FIG. 5 is a view from above of the fuse of the device of FIG. 3;

FIG. 6 illustrates the device of FIG. 3 after it has been actuated;

FIG. 7 is a view similar to FIG. 1 after the isolating device has been actuated;

FIG. 8 is a third example of an electrical circuit according to the invention;

FIG. 9 illustrates an accumulator-isolating device according to a second embodiment of the invention;

FIG. 10 illustrates an accumulator-isolating device according to a third embodiment of the invention;

FIG. 11 illustrates an accumulator-isolating device according to a fourth embodiment of the invention;

FIG. 12 illustrates an accumulator-isolating device according to a fifth embodiment of the invention;

FIG. 13 illustrates an accumulator-isolating device according to a sixth embodiment of the invention;

FIG. 14 illustrates an accumulator-isolating device according to a seventh embodiment of the invention;

FIG. 15 illustrates an accumulator-isolating device according to an eighth embodiment of the invention;

FIG. 16 illustrates a variant embodiment of the accumulator-isolating device.

### DETAILED DESCRIPTION

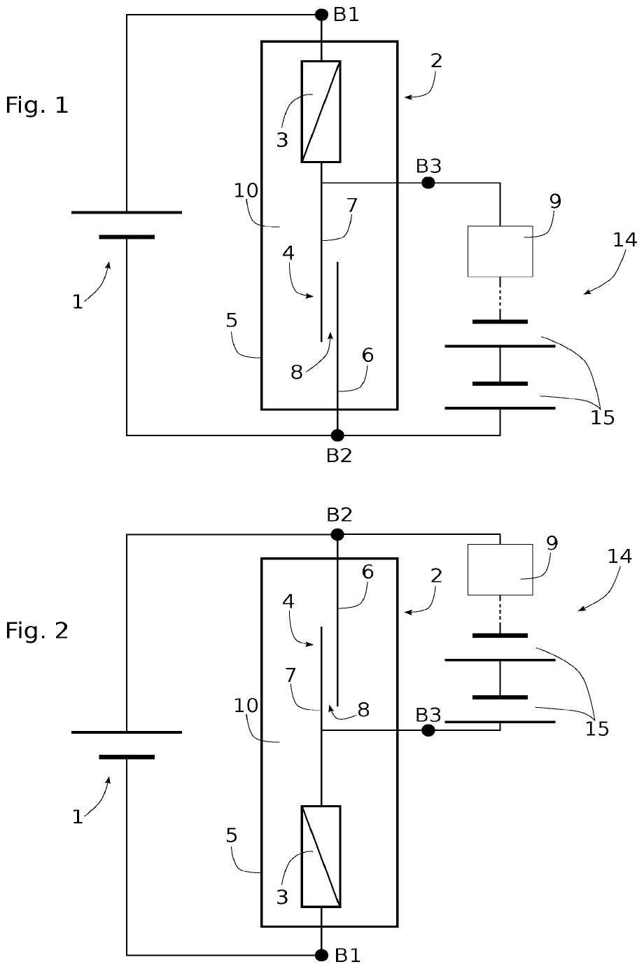

FIGS. 1 and 2 each illustrate one example of an electrical circuit in which a battery of electrical accumulators 1, 15 connected in series supplies power to a load 9. The load 9 schematically illustrates any electric machine or circuit supplied with power by a battery.

The circuits illustrated in FIGS. 1 and 2 are arranged so that one of the accumulators (here accumulator 1) is associated with an electrical-accumulator-isolating device 2. The electrical accumulator 1 may be any known type of electrical accumulator, and notably a lithium-ion accumulator, or an accumulator of another lithium-based chemistry such as a lithium-metal chemistry, or even be based on the intercalation of other ions such as is the case in sodium-ion or potassium-ion chemistries.

This electrical accumulator 1 may be a unit accumulator (a battery cell) or a set of accumulators mounted in series and/or in parallel. Whatever the form of the accumulator 1, the illustrated schema allows the accumulator 1 to be isolated from the electrical circuit 14 to which it is connected, while ensuring a bypass allowing the other accumulators 15 to continue to supply the load 9 with power. In the illustrated example, the electrical circuit 14, which is formed by the other accumulators 15 and the load 9, represents the elements from which the accumulator 1 may be isolated in case of a fault in the latter.

The isolating device 2 comprises:
a first terminal B1 that is connected to a first terminal of the accumulator 1;
a second terminal B2 that is connected to the other terminal of the accumulator 1 and to the electrical circuit 14; and
a third terminal B3 that is connected to the electrical circuit 14.

The following functions are performed by the isolating device 2:
disconnection of the accumulator 1 and of the electrical circuit 14 10 (schematically shown by a fuse 3);
connection of the terminals B2 and B3 (schematically shown by a bypass device 4).

FIG. 1 illustrates an example in which the terminal B1 is connected to the positive terminal of the accumulator 1, and the terminal B2 is connected to the negative terminal of the accumulator 1 (accumulator 1 isolated by disconnection of its negative terminal).

FIG. 2 for its part illustrates an example in which the terminal B1 is connected to the negative terminal of the accumulator 1, and the terminal B2 is connected to the positive terminal of the accumulator 1 (accumulator 1 isolated by disconnection of its positive terminal).

The isolating device 2 may be a device external to the accumulator 1, and which is connected to the latter, or may be internal to the casing of the accumulator 1, or even internal to the battery pack containing all of the accumulators 1, 15.

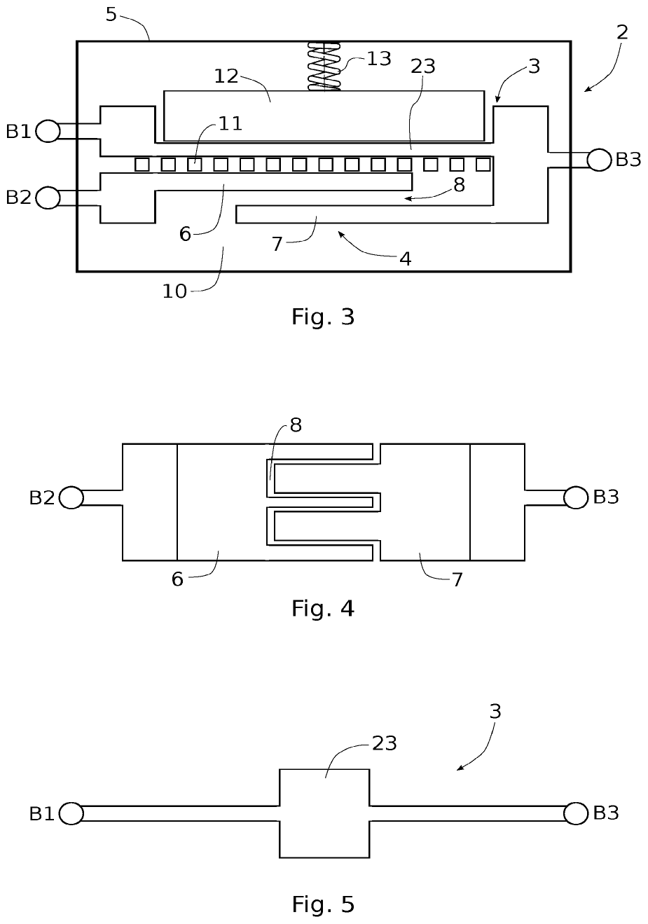

FIG. 3 schematically illustrates the isolating device 2 according to a first embodiment. According to this first embodiment, the isolating device 2 is actuated by an overcurrent between the terminals B1 and B3. The isolating device 2 here comprises a casing 5 bearing the connection terminals B1, B2, B3 that defines an internal space forming a bypass chamber 10, in which is placed a bypass device 4. The bypass device 4 comprises a first bypass conductor 6 and a second bypass conductor 7, which are separated by at least one gap 8.

The first bypass conductor 6 is connected to the terminal B2, whereas the second bypass conductor 7 is connected to the terminal B3. In the nominal operating state of the isolating device 8, i.e. when it has not been actuated, the gap 8 is filled with an electrical insulator that is, in the present example, air or any other suitable gas.

FIG. 3 is a schematic representation in which the gap 8 is a simple separation between the two bypass conductors 6, 7. FIG. 4 schematically illustrates the bypass conductors 6, 7 seen from above, each thereof comprising, in this example, an end, these ends having complimentary geometric shapes, these shapes being interdigitated, although separated by the gap 8. The gap 8 is then placed along these geometric shapes, forming a gap 8 of crenellated shape in this example.

A fuse 3 is also placed in the bypass chamber 10. This fuse 3 comprises, in this example, a conductor 23 made of meltable material that is connected on the one hand to the terminal B1 and on the other hand to the terminal B3 (and therefore also to the second short-circuit conductor 7). The fuse 3 may moreover be formed by placing various meltable sections in parallel.

FIG. 5 is a view from above of the fuse 3. The schematic representation of FIG. 5 illustrates the fact that the conductor 23 is intended to fill the gap 8, at least partially, and that the shape and volume of the conductor 23 are configured to ensure a sufficient amount of meltable material is located facing the bypass conductors 6, 7 and more precisely facing the gap 8.

An insulator 11 is in addition placed in the bypass chamber 10, between the fuse 3 and the bypass device 4. In the present example, this insulator 11 is illustrated in the form of a dielectric sheet that is perforated or porous, and hence configured to let the material from which the conductor 23 is made pass when this material is in the liquid state after it has been melted in the fuse 3.

Optionally, a dielectric buffer 12 exerts a pressure on the conductor 23 made of meltable material, in the direction of the bypass conductors 6, 7, under the effect of elastic means, such as a spring 13.

The conductor 23 is made of a material that has a melting point that will be reached during an overcurrent exceeding a predetermined value, so as to act as a conventional fuse. Thus, in case for example of a short-circuit affecting the accumulator 1, the conductor 23 in the fuse 3 melts and opens the circuit.

However, the fuse 3 is here arranged so that the volume of meltable material from which the conductor 23 is made at least partially fills the gap 8, as the conductor 23 melts.

The material from which the fuse 3 is made is preferably a material of low melting point (below 400° C. for example), this for example being the case for lead-tin alloys or for the lead-free alloys that have replaced lead-tin alloys in solders. The use of a metal or of an alloy that is by nature less conductive than copper runs contrary to the general principles of production of modern fuses, and requires a larger amount of substance to be used to produce the section of the fuse 8. Although not optimal in the context of production of a conventional fuse, this use of a low-melting-point metal or alloy is in contrast optimal in the context of the invention, in which the increase in the amount of substance required to produce the fuse 3 goes hand-in-hand with an increase in the amount of molten material that will, on actuation of the isolating device 2, fill the gap 8.

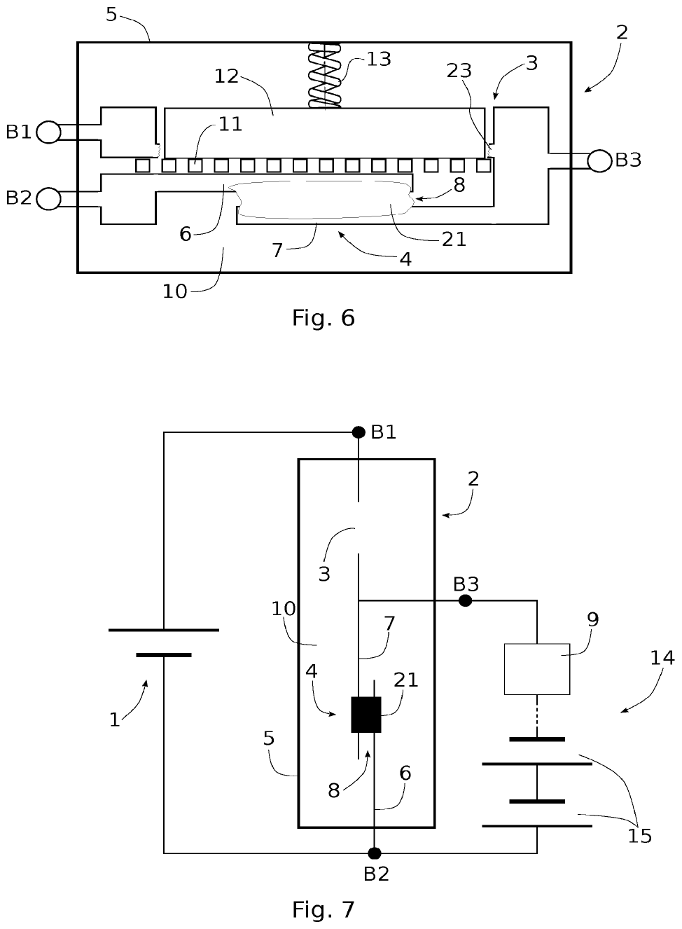

FIG. 6 illustrates the isolating device 2 of FIG. 3 after it has been actuated, i.e. in a configuration in which the accumulator 1 is isolated. The isolating device 2 is actuated when a current threshold is crossed, said threshold being calibrated in a conventional manner by means of the dimensions of the cross section of the fuse 3 and of the choice of the material from which it is made. In the context of an electric-automobile application, for example, this current threshold is of the order of several hundred amps.

The overcurrent flowing through the fuse 3 causes the conductor 23 to heat up until the meltable material from which it is made melts. This material, on melting, becomes liquid, and then passes through the insulator 11 under the effect of gravity and/or of the pressure of the buffer 12.

The material of the conductor 23, in the liquid state, gets deposited in the gap 8 and forms a solder joint 21 between the bypass conductors 6, 7.

Preferably, the surface finish of the bypass conductors 6, 7 is prepared (via a surface treatment, tinning, or any other suitable measure) to facilitate the adhesion of the material of the conductor 23 in the liquid state.

Melting of the fuse 3 therefore has indissociable consequences:
the electrical circuit is broken between the terminals B1 and B3;
a bypass electrical connection, of very low resistance, is formed between the terminals B2 and B3.

The casing 5, which bounds the bypass chamber 10, is made of a material that is resistant to the temperatures of the material of the conductor 23, when it is in the liquid state. The casing 5 may for example be made from a refractory ceramic that is resistant to very high temperature levels if necessary. In the present example, since the material of the conductor 23 is of low melting point, the casing 5 is preferably made from a suitable polymer, of polyimide for example. The insulator 11 may also be made of polyimide.

The equivalent circuit (returning to the example of FIG. 1) of the isolating device 2 once it has been actuated is illustrated in FIG. 7. In this isolating configuration, the accumulator 1 is kept isolated from the circuit by disconnection of its positive terminal, whereas the electrical circuit 14 is closed by the solder joint 21, and hence the other electrical accumulators 15, which were precedingly present in the same branch in series with the accumulator 1, remain connected in series and remain connected to the load 9.

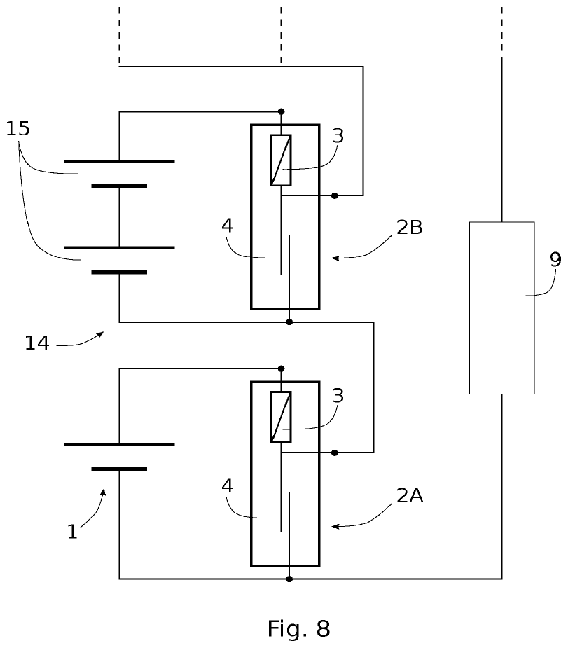

The isolating device 2 here acts on the accumulator 1. All the accumulators, or groups of accumulators, of a series or parallel branch, may be associated with their own isolating device. FIG. 8 illustrates an example in which the accumulator 1 is associated with its own isolating device 2A, and in which a group consisting of the other accumulators 15 is associated with its own isolating device 2B.

The accumulators or groups of accumulators may thus be mounted in cascade in a battery pack, with as many isolating devices 2 as required, with a view to supplying the load 9 with power. Failure of one of the accumulators will actuate its isolating device 2 and lead to this accumulator being isolated as described above.

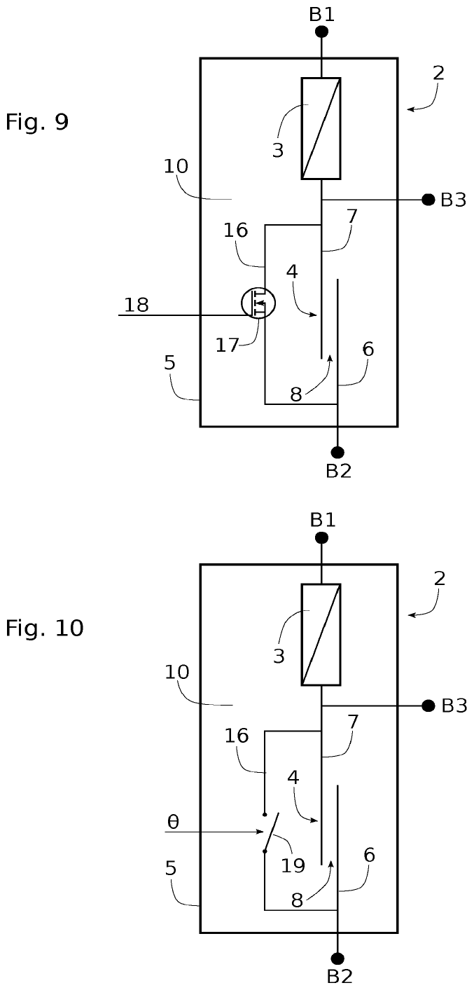

FIG. 9 illustrates an electrical-accumulator-isolating device 2 according to a second embodiment of the invention. In the various embodiments, similar elements have been designated with the same reference numbers in the figures.

In this second embodiment, the isolating device 2 has a similar architecture to the isolating device of the first embodiment, with the exception that, inside the casing 5, the isolating device 2 comprises a control branch 16 connected in parallel with the bypass device 4, between the terminals B2 and B3.

In this second embodiment, the isolating device 2 may not only be actuated naturally (by an overcurrent as described with respect to the first embodiment) but also in a controlled manner. The isolating device may for example be actuated by the battery management system (BMS) when it identifies a fault affecting the accumulator (temperature too high or other monitored parameters out of range).

The control branch 16 comprises a controlled switch such as a relay or, as in the illustrated example, a power transistor 17. The transistor 17 is for example a MOSFET that has a very low parasitic resistance and that is able to let pass currents of several hundred amps, compatible with melting the fuse 3.

The control 18 of the transistor 17 thus receives a signal corresponding to an isolation instruction and causes the control branch 16 to close, this short-circuiting the accumulator 1 and thus actuating the isolating device 2 as described above in the context of the first embodiment.

After the isolating device 2 has been actuated, if the transistor 17 is destroyed by the short-circuit current, it may nevertheless continue to let this current pass for a certain time. In any case, the situation resulting from actuation of the isolating device 2 following a command 18 results in an equivalent circuit corresponding to FIG. 7.

In this second embodiment, the isolating device thus has:
a first mode of actuation following an overcurrent, as in the first embodiment;
a second mode of actuation controlled by a signal on the control 18.

FIG. 10 illustrates a third embodiment that is similar to the second embodiment, with the exception that the control branch 16 is here a branch controlled in respect of temperature θ.

The control branch 16 here comprises a thermal switch 19 that is a normally open switch that closes when the temperature 8 exceeds a predetermined threshold. In this third embodiment, the isolating device 2 thus has two modes of actuation:
a first mode of actuation that is identical to that of the first embodiment;
a second mode of actuation that is triggered when the temperature of the accumulator 1 (or of another element thermally coupled to the isolating device 2) exceeds a certain threshold.

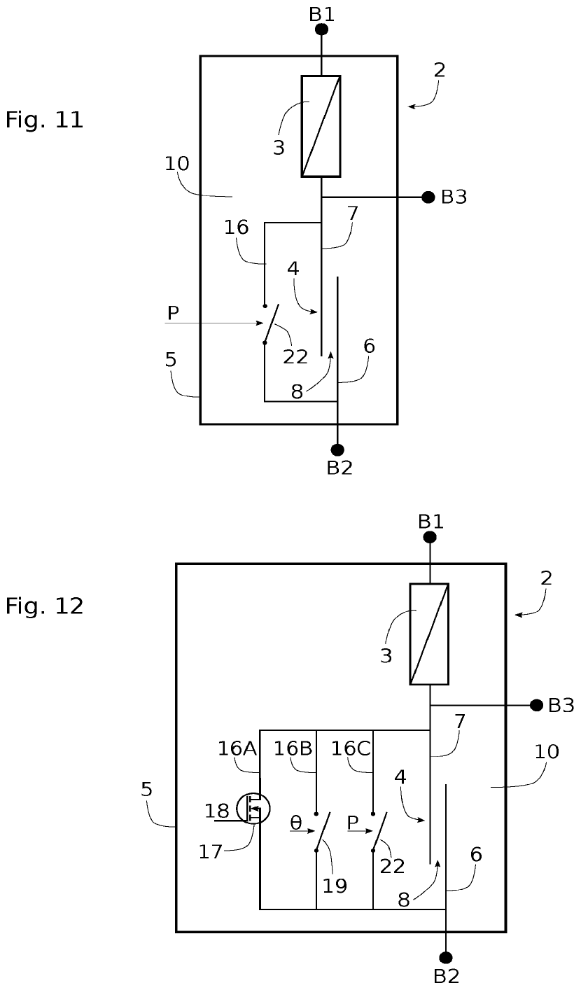

FIG. 11 illustrates a fourth embodiment of the invention that is similar to the third embodiment, with the exception that the control branch 16 is controlled in respect of pressure P.

The control branch 16 here comprises a pressure switch 22 that is a normally open switch that closes when the pressure P exceeds a predetermined threshold. In this fourth embodiment, the isolating device 2 thus has two modes of actuation:
a first mode of actuation that is identical to that of the first embodiment;
a second mode of actuation that is triggered when the internal pressure of the accumulator 1 (or of another element mechanically coupled from the point of view of pressure to the isolating device 2) exceeds a certain threshold.

FIG. 12 illustrates an isolating device 2 according to a fifth embodiment of the invention, corresponding to a combination of the preceding embodiments.

The isolating device 2 here comprises, mounted in parallel with the bypass device 4:
a first control branch 16A controlled by a control signal 18;
a temperature-controlled second control branch 16B, with a switch 19 switched in respect of temperature θ;
a pressure-controlled third control branch 16C, with a switch 22 switched in respect of pressure P.

In this fifth embodiment, the isolating device 2 thus has four modes of actuation:
a first mode of actuation following an overcurrent, as in the first embodiment;
a second mode of actuation controlled by a signal on the control 18, as in the second embodiment;
a third mode of actuation that is triggered when the temperature of the accumulator 1 (or of another element thermally coupled to the isolating device 2) exceeds a certain threshold, as in the third embodiment;
a fourth mode of actuation that is triggered when the internal pressure of the accumulator 1 (or of another element mechanically coupled from the point of view of pressure to the isolating device 2) exceeds a certain threshold, as in the fourth embodiment.

The isolating device 2 may moreover include any other type of control branch 16 comprising a switch configured to close depending on a particular physical parameter that is relevant to detection of a fault in the accumulator 1, for a particular application.

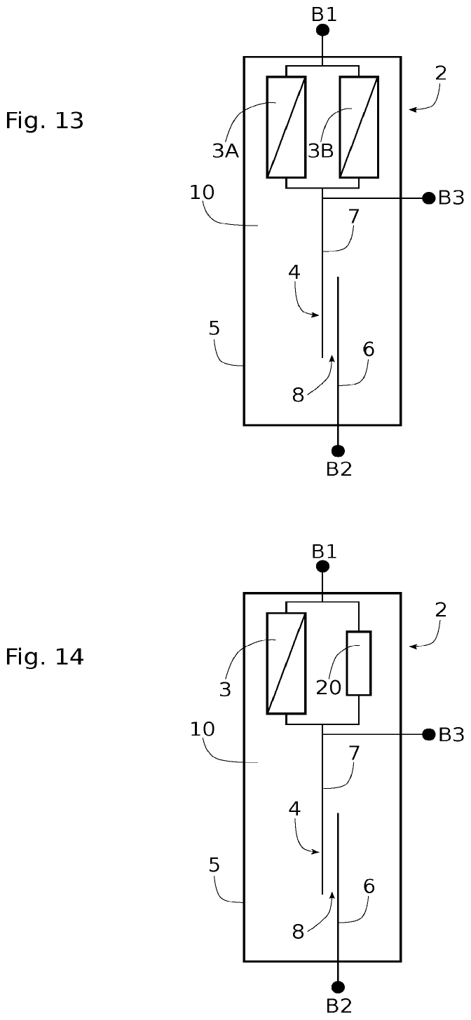

FIG. 13 illustrates an isolating device according to a sixth embodiment of the invention, in which embodiment the fuse function 3 is performed by two fuses 3A, 3B in parallel.

The first fuse 3A and the second fuse 3B each similarly comprise a conductor made of meltable material. The conductor made of meltable material of the first fuse 3A has a melting point that is below the melting point of the conductor of the second fuse 3B. The two fuses 3A, 3B are thermally coupled. They may simply be placed together in the bypass chamber 10, or may comprise elements specifically provided to thermally couple them.

On actuation of the isolating device 2, following an overcurrent, the bypass conductors 6, 7 are soldered with molten material and the gap 8 is filled in two steps. Heating of the two fuses 3A, 3B, following the overcurrent, firstly causes the first fuse 3A to melt and this melting continues beyond rupture of the conductor of the fuse 3A, under the effect of concomitant heating of the fuse 3B.

From the melting point of the conductor of the second fuse 3B, the latter also passes to the liquid state and the isolating function of the accumulator 1 is thus performed.

This arrangement guarantees that, when the fuse 3 melts, at least the first fuse 3A sees its conductor mainly pass to the liquid state, avoiding the drawbacks of a premature rupture potentially interrupting the increase in temperature and melting of the conductor.

FIG. 14 illustrates a seventh embodiment of the invention, in which embodiment a discharge resistor 20 is placed in the casing 5, in parallel with the fuse 3.

In this seventh embodiment, when the isolating device 2 is triggered, the accumulator 1 is well isolated by the fuse 3A melting. However, the terminals of the accumulator 1 are then, after the actuation, still connected to the discharge resistor 20. The accumulator 1 then discharges through the resistor 20.

This embodiment provides additional security because the accumulator exhibiting an anomaly discharges through the discharge resistor 20. The faulty accumulator is thus not only isolated from the circuit but in addition discharged of the energy that it contains.

The discharge resistor 20 is dimensioned depending on the maximum amount of energy to be discharged from the accumulator 1, and on the time that it is desired for the discharge to take. The resistance of the discharge resistor 20 also depends on the ability to remove the generated heat. This discharge resistor 20 may for example be dimensioned to slowly discharge the accumulator, in a way that generates limited heating and that is suitable for configurations in which it is difficult to remove the generated heat. The discharge resistor 20 may in contrast be dimensioned for a more rapid discharge, generating a lot of heating. In the latter case, advantage is taken of the temperature to which the discharge resistor 20 is heated to continue heating the fuse 3 beyond the melting point of its conductor, and thus to guarantee a complete transfer of molten substance to the bypass device 4. The discharge resistor 20 thus completes the work of melting the fuse 3.

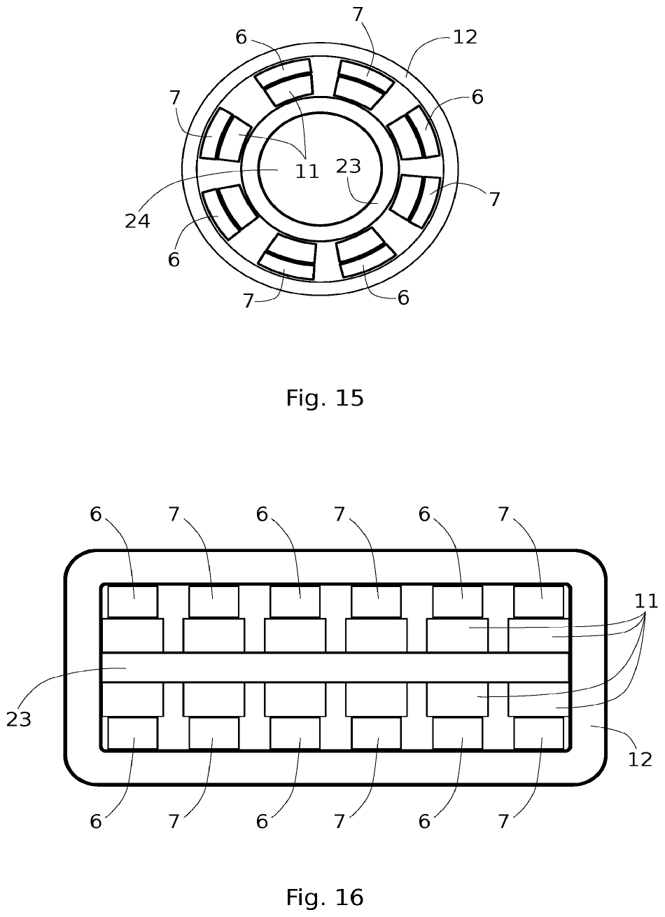

FIG. 15 illustrates an eighth embodiment of the invention in which the conductor made of meltable material is configured, when it is in the liquid state, to flow under gravity onto the bypass conductors whatever the position of the isolating device. To this end, the bypass conductors 6, 7 are arranged all around the fuse 3.

With reference to FIG. 15, the meltable material 23 is arranged on a central hub 24. The meltable material 23 may melt when it is passed through by a current higher than its threshold current. Whatever the spatial position of the isolating device, the liquid molten material may pass between the holes of the electrical insulator 11 in order to ensure electrical conduction between certain of the fingers of the bypass conductors 6 and 7.

The bypass conductors 6, 7 are surrounded by a buffer 12 taking the form of a closed membrane that allows, over and above gravity, transfer of substance to be promoted via a bearing force applied by the membrane 12, if the latter is elastic, compressed by a spring function or made of a heat-shrink material (see the variant described below).

As a variant, the membrane 12 is replaced by a rigid jacket, and the meltable material, once melted, moves only under gravity.

Moreover, various solutions are possible as regards application of the force that makes the substance of the meltable material migrate once molten. Various examples of these solutions are listed below.

According to a first example of said solutions, rather than have a buffer 12 pushed by a spring, it is possible to employ a buffer taking the form of a membrane that is pressed by an elastic material (a foam for example), or even a buffer taking the form of an elastic membrane that is kept deformed by the solid substance of the fuse, and that regains its shape when the fuse melts, thus driving the molten substance toward the zone of the bypass conductors 6, 7. The buffer 12 (which takes the form shown in FIGS. 3 and 6, or takes the form of a membrane as in FIG. 15) is defined to be an element that exerts a pressure on the conductor 23 made of meltable material, forcing it toward the bypass conductors 6, 7, under the effect of elastic means (such as the spring 13 of FIGS. 3 and 6), or of the elasticity of the buffer 12 itself, notably when the latter takes the form of a membrane (as in FIG. 15), or even under the effect of thermal expansion of the buffer 12, or of shrinkage of the buffer when it is made of a heat-shrink material.

A second example of said solutions uses forces due to expansion of a material. For example, the buffer 12 (without spring this time) may be made of silicone, of a high-temperature polymer having a high coefficient of expansion, or of a silicone foam the pores of which are closed, in which case the expansion will mainly be due to expansion of the gas enclosed in the pores. This buffer 12, via its increase in volume following the increase in temperature, will force the conductor 23 once liquid toward the zone of the bypass conductors 6, 7.

A third example of said solutions uses forces due to surface tension as a substance-transfer solution. For example, the conductor 23 made of meltable material may have an elongate and for example cylindrical shape in the solid state. On melting, the material of this conductor 23 will become ball-shaped in the liquid state, and the height of the ball will be larger than the diameter of the initial cylinder, allowing the zone of the bypass conductors 6, 7 to be wetted even if this zone is located above the conductor 23 made of meltable material. Surface tension also 10 allows movement under the effect of capillarity.

With reference to FIG. 16, a fourth example of said solutions uses a heat-shrink polymer. Thus, over and above gravity, the transfer of substance may be promoted by a bearing force applied by the buffer 12, which in this example is a membrane encircling the isolating device. This membrane on shrinking may apply a pressure that tends to drive the meltable material 23, when it is liquid, through the holes in 11 to fill the space between the fingers of the bypass conductors 6 and 7. The pressure may be applied by the buffer 12 if the membrane from which it is formed is elastic, pressed by a spring or made of a heat-shrink material. By way of heat-shrink material suitable for the temperature range of a molten tin alloy for example, mention may be made of cross-linked PVDF.

The heat-shrink polymer may encircle the bypass conductors 6, 7, which themselves encircle the conductor 23 made of meltable material (as in FIG. 16). As a variant, the heat-shrink polymer may encircle the conductor 23 made of meltable material, which itself encircles the bypass conductors 6, 7.

According to a fifth example of said solutions, the movement of the conductor 23 once molten may also be achieved using magnetic forces, the magnetic field either being generated by the current flowing through the device or delivered by a magnet.

Thus, there are many techniques that may be used to make the conductor 23 migrate, when it is in the liquid state, to the bypass conductors 6, 7, these techniques notably employing gravity, surface tension, electromagnetism, a permanent elastic mechanical pressure, or a heat-activated mechanical pressure (due to thermal expansion or heat-activated shrinkage). These techniques may be implemented independently or combined.

Moreover, various alternatives are possible as regards the isolation between the zone of the conductor 23 made of meltable material and the zone of the bypass conductors 6, 7. For example, the electrical insulator 11 may be able to retract when it is subjected to the temperature of the conductor 23 made of meltable material in the liquid state, in order to leave more space for the molten substance to pass (by virtue of use of a heat shrink, for example).

According to another example, the electrical insulator 11 may be made of a material that is destroyed when it is subjected to the temperature of the conductor 23 made of meltable material when the latter is in the liquid state.

Variants of embodiment may be implemented. Notably, any form of interdigitation of the bypass conductors 6, 7 may be employed, notably depending on the conductive cross-sectional area required for the gap 8, when the latter is filled with the meltable material of the fuse 3. The conductor 23 made of meltable material may be placed facing the bypass device 4, as in the example of FIG. 3, but these elements may also be placed in any mutual position allowing a transfer of the material in the liquid state of the conductor 23 to the bypass device 4 (for example via elements that channel this material in the liquid state, and/or taking advantage of the effects of gravity, of capillarity, of surface tension in the liquid state and/or of application of an exterior force).

Moreover, the various embodiments may be combined together.

1. An electrical-accumulator-isolating device configured to isolate an electrical accumulator of an electrical circuit while ensuring continuity of the electrical circuit, comprising:
a first terminal configured to connect the isolating device to the electrical accumulator;
a second terminal configured to connect the isolating device to the electrical accumulator and to the electrical circuit;
a third terminal configured to connect the isolating device to the electrical circuit;
a bypass chamber in which is placed a bypass device that comprises two bypass conductors that are separated by a gap, one of the bypass conductors being connected to the second terminal and a second one of bypass conductors being connected to the third terminal; and
a fuse comprising a conductor made of meltable material connected between the first terminal and the third terminal, the conductor made of meltable material being placed in the bypass chamber, and being configured to transfer in a liquid state to the bypass device.

2. The device according to claim 1, wherein the conductor made of meltable material is placed facing the bypass conductors.

3. The device according to claim 1, wherein the fuse is calibrated to ensure the conductor made of meltable material melts when a magnitude of current flowing through the fuse exceeds a predetermined threshold value.

4. The device according to claim 1, wherein the bypass conductors are arranged below the fuse, the conductor made of meltable material being configured, when in the liquid state, to flow under gravity onto the bypass conductors.

5. The device according to claim 1, wherein the bypass conductors are arranged all the way around the fuse, the conductor made of meltable material being configured, when in the liquid state, to flow under gravity onto the bypass conductors.

6. The device according to claim 1, wherein it comprises a buffer that forces the conductor made of meltable material in the direction of the bypass conductors.

7. The device according to claim 1, comprising an electrical insulator placed between the fuse and the bypass conductors, the electrical insulator being configured to let the meltable material of the conductor pass when in the liquid state.

8. The device according to claim 1, wherein the conductor made of meltable material has a melting point below 400° C.

9. The device according to claim 1, wherein the bypass conductors have interdigitated complementary geometric shapes, the gap being placed along the geometric shapes.

10. The device according to claim 1, wherein the bypass conductors have a surface finish configured to be soldered by the meltable material of the conductor when in the liquid state.

11. The device according to claim 1, comprising at least one control branch placed between the second terminal and the third terminal, in parallel with the bypass device, the control branch comprising at least one controlled switch.

12. The device according to claim 11, wherein the at least one controlled switch of the control branch comprises a switch switched by a signal.

13. The isolating device according to claim 11, wherein the at least one controlled switch of the control branch comprises a switch switched by a temperature threshold being crossed.

14. The device according to claim 11, wherein the at least one controlled switch of the control branch comprises a switch switched by a pressure threshold being crossed.

15. The device according to claim 1, wherein the fuse comprises two conductors made of meltable material mounted in parallel, one of the two conductors having a melting point above a melting point of the other conductor.

16. The device according to claim 1, comprising a discharge resistor mounted in parallel with the fuse.

17. The isolating device according to claim 1, wherein the conductor made of meltable material is configured to transfer in the liquid state to the bypass device under one of gravity, surface tension, electromagnetic stress, permanent elastic mechanical pressure, and heat-activated mechanical pressure.

18. An electrical circuit comprising a first electrical accumulator, at least one second electrical accumulator, and a load supplied with power by the electric accumulators, comprising an electrical-accumulator-isolating device according to claim 1, wherein:
the first terminal is connected to a terminal of the first electrical accumulator;
the second terminal is connected to another terminal of the first electrical accumulator and to a terminal of said the load;
a third terminal of which is connected to another terminal of the load; and
the electrical-accumulator-isolating device is configured to isolate the first electrical accumulator from the second electrical accumulator and from the load, while ensuring continuity of supply of power to the load by the second electrical accumulator.

19. The electrical circuit according to claim 18, wherein the first electrical accumulator and the at least one second electrical accumulator are mounted in series with the load via the fuse.

20. A method for isolating an electrical accumulator with respect to an electrical circuit using an electrical-accumulator-isolating device according to claim 1, comprising:
subjecting the fuse to an overcurrent that heats the conductor made of meltable material to above its melting point; and
transferring at least one portion of the conductor made of meltable material in the liquid state to the gap separating the bypass conductors.
